(19) United States
(12) Patent Application Publication
(10) Pub. No.: US 2020/0131057 A1
(43) Pub. Date: Apr. 30, 2020

(54) EXTERNALLY ENHANCED ELECTROCOAGULATION

(71) Applicant: William Jansen, Bloomington, MN (US)

(72) Inventor: William Jansen, Bloomington, MN (US)

(21) Appl. No.: 16/712,034

(22) Filed: Dec. 12, 2019

Related U.S. Application Data
(63) Continuation-in-part of application No. 15/375,454, filed on Dec. 12, 2016, now abandoned.
(60) Provisional application No. 62/267,082, filed on Dec. 14, 2015.

(51) Int. Cl. C02F 1/463; C02F 1/52

(52) U.S. Cl. CPC C02F 1/463; C02F 2001/46157; C02F 1/5236

(57) ABSTRACT

A water treatment system including a reaction chamber having an anode and a cathode is presented. The reaction chamber is configured to conduct an electrocoagulation reaction between the anode and the cathode. The water treatment system also includes an external ion generator, separate from the anode, configured to provide free metal ions to the water treatment system.

### CROSS-REFERENCE TO RELATED APPLICATION

The present application is based on and claims the benefit of U.S. Provisional Patent Application Ser. No. 62/267,082 filed Dec. 14, 2015 and U.S. Nonprovisional patent application Ser. No. 15/375,454 filed Dec. 12, 2016, the content of which are hereby incorporated by reference in their entirety.

### BACKGROUND

Electrocoagulation is an economical water treatment technology. Electrocoagulation includes, for example, applying an electrical charge to water such that particle surface charges change. Electrocoagulation facilitates the suspension of particulates, forming a more-easily removed agglomeration. In addition, electrocoagulation can reduce the amount of necessary filters, additives, and other chemicals needed to remove suspended solids, oil, grease and heavy metals from a water treatment stream.

The discussion above is merely provided for general background information and is not intended to be used as an aid in determining the scope of the claimed subject matter.

### SUMMARY

A water treatment system including a reaction chamber having an anode and a cathode is presented. The reaction chamber is configured to conduct an electrocoagulation reaction between the anode and the cathode. The water treatment system also includes an external ion generator, separate from the anode, configured to provide free metal ions to the water treatment system.

### BRIEF DESCRIPTION OF THE DRAWINGS

The drawings included in the present application are incorporated into, and form part of, the specification. They illustrate examples of the present disclosure and, along with the description, serve to explain the principles of the disclosure. The drawings are only illustrative of certain examples and do not limit the disclosure.

FIG. 1 illustrates a prior art waste treatment reaction cell.

FIG. 2 is a diagram showing an example water treatment system.

FIG. 3A is a diagram showing an example water treatment system.

FIG. 3B is a diagram showing the example reaction chamber of FIG. 3A.

FIG. 4A is a diagram showing an example external ion generator.

4B is an illustrative diagram showing an example reaction in the example external ion generator of FIG. 4A

FIG. 5 is a diagram showing an example water treatment system with multiple chambers.

FIG. 6 is a diagram showing an example treatment system with a recycle.

FIG. 7 is a flow diagram showing an example method of treating waste water.

While examples of the present invention are amenable to various modifications and alternative forms, specifics thereof have been shown by way of example in the drawings and will be described in detail. It should be understood, however, that the intention is not to limit the invention to the particular examples described. On the contrary, the intention is to cover all modifications, equivalents, and alternatives falling within the spirit and scope of the invention

### DETAILED DESCRIPTION

Electrocoagulation and electroflotation are rapidly growing areas of waste water treatment due to their ability to remove contaminants that are generally more difficult to remove by filtration or chemical treatment systems, such as emulsified oil, total petroleum hydrocarbons, refractory organics, suspended solids, and/or heavy metals. Electrocoagulation is accomplished by a reaction chamber, within an electrocoagulation system, that provides a charge to a water-based solution having contaminants. This involves applying a voltage across a pair of electrodes to produce metal and hydroxide ions that, in solution, allow the contaminants to form as a mass or floc, which can be removable from the solution through filtration or separation. This mass of contaminants, or floc, is removable from the reaction chamber as floating waste or sediment waste based on the density of the mass.

In a water-based environment, heavy metals and waste products, organic and inorganic, are primarily held in solution by electrical charges. The production of ions through electrocoagulation allows for a destabilization of those electrical charges keeping the heavy metals and waste products, organic and inorganic, in solution. This destabilization allows the particulates to coagulate and form a mass, or floc, which can be removed as floating waste or sediment waste.

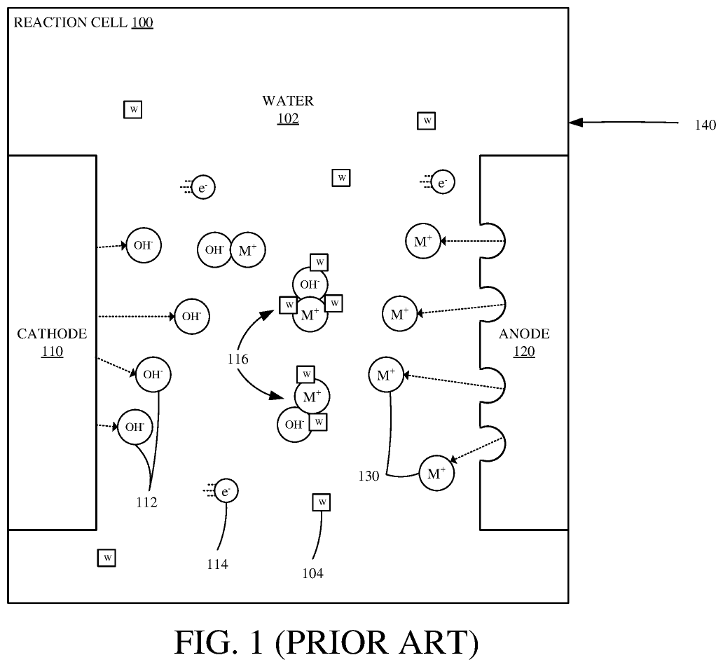

FIG. 1 illustrates a prior art waste treatment reaction cell. Reaction cell 100 holds and treats water 102 which contains waste 104. To treat water 102 reaction cell 100 includes two electrodes, a cathode 110 electronically coupled to an anode 120. When a charge is applied across the electrodes, electrons 114 flow through water 102 from cathode 110 to anode 120. These electrons 114 destabilize surface charges on waste 104 (e.g., suspended solids and emulsified oils, for example). Additionally, metals ions 130 are produced from anode 120 and hydroxide ions 112 are produced from cathode 110. The metal ions 130 complex with hydroxide ions 112 to form flocs 116. Flocs 116 coagulate and attract waste 104 and other flocs 116 to form larger flocs that can be removed by filtration, floating separation or sedimentary separation.

As shown, the generation of metal ions 130 over-time degrades anode 120, while the generation of hydroxide ions 131 does not degrade cathode 110. As anode 120 is used, it will shrink in size over time as it produces metal ions 130, such that it eventually needs to be replaced, which can be labor intensive. Replacement may also require interruption of the electrocoagulation process. As shown, anode 120 can provide at least a portion of a barrier 140 surrounding reactor cell 100. Therefore, as anode 120 produces ions 130 and degrades, it can result in leaks forming within barrier 140.

Therefore, an electrocoagulation system that receives ions from an external source, separate from cathode 110 and anode 120, is desired. For example, having an electrocoagulation system receive ions from an external source allows for an electrocoagulation reaction to proceed without generating ions at an anode-cathode assembly, and degrading the anode. Such an arrangement ensures that the anode in the anode-cathode assembly does not need to be replaced periodically. Additionally, this could allow for a reduced current at the anode-cathode assembly such that the water is only electrolyzed (such that surface charges on suspended oils and emulsified oils, for example, are destabilized) or that only hydroxide ions and hydrogen gas are generated. At least some of the examples described herein provide such a system.

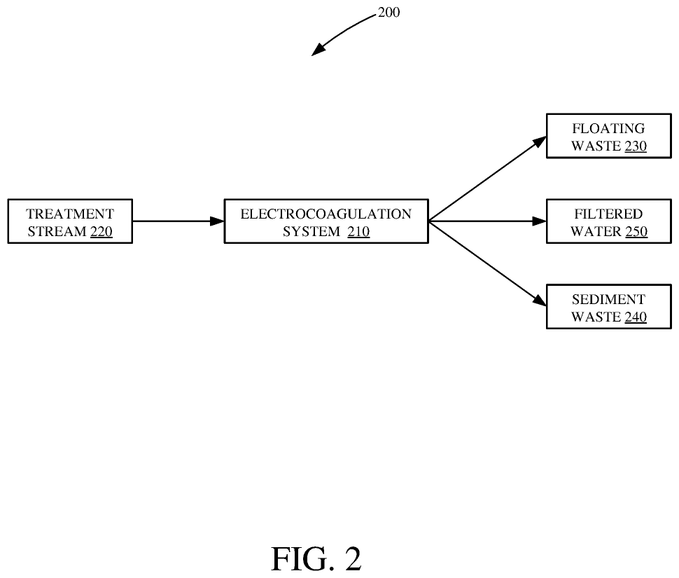

FIG. 2 is a diagram showing an example waste water treatment system. Water treatment system 200 includes an electrocoagulation system 210 that receives a water treatment stream 220 having at least some water with suspended contaminants. Electrocoagulation system 210 conducts an electrocoagulation reaction and delivers filtered water 250 as an output. The electrocoagulation reaction is conducted using metal ions and hydroxide ions supplied from an external ion source, such that an anode-cathode assembly within electrocoagulation system 210 does not produce metal ions through anode degradation alone. The electrocoagulation reaction produces floc from the suspended contaminants within water treatment stream 220. Lower density floc flows to the top of electrocoagulation system 210 and is removed as floating waste 230. Higher density floc falls to the bottom of electrocoagulation system 210 and is removed as sediment waste 240. It is understood that a mixture of floating waste 230 and sediment waste 240 can both be generated based on the density of the floc.

As the electrocoagulation reaction progresses within electrocoagulation system 210, a cathode-anode pair within electrocoagulation system 210 electrolyzes water within treatment stream 220, producing hydroxide ions and hydrogen gas. The production of hydrogen gas increases available surface area for the electrocoagulation process and facilitates the production of floc. While the cathode-anode pair produces hydroxide ions and hydrogen gas within electrocoagulation system 210, a separate ion source provides metal ions and additional hydroxide ions to electrocoagulation system 210. When introduced into electrocoagulation system 210, the hydroxide ions and metal ions generated from the separate ion source hydrolyze into polymeric ions which act as coagulating agents. This allows for an accumulation of floc within electrocoagulation system 210 without needing to generate metal ions and hydroxide ions at a cathode-anode assembly within electrocoagulation system 210.

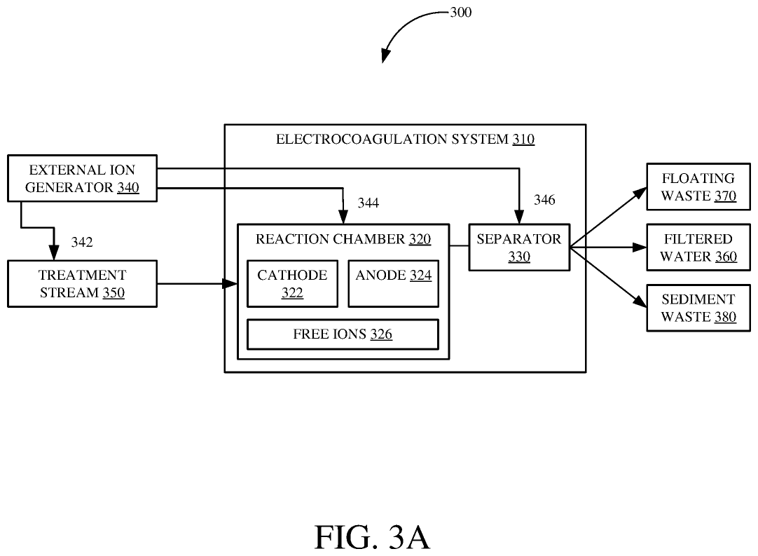

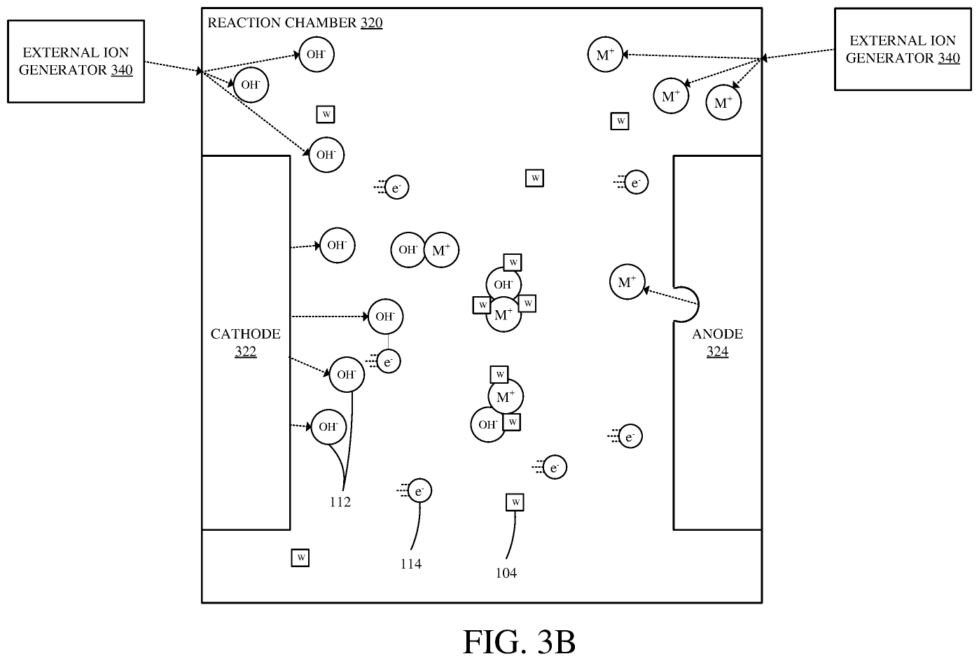

FIG. 3A is a diagram showing an example water treatment system. Water treatment system 300 includes an electrocoagulation system 310. The electrocoagulation system 310 is receives a treatment stream 350 and produces filtered water 360. Treatment stream 350 includes waste water with unwanted contaminants. Based on the contaminants within treatment stream 350 after engaging an electrocoagulation reaction within a reaction chamber 320, floc is produced from the contaminants and is ejected as either floating waste 370 or sediment waste 380, based on density, for example. In some examples, a separator 330 is used in conjunction with reaction chamber 320, such that floating waste 370 or sediment waste 380 is removed in a separation operation (e.g., a skimmer is provided to catch floating waste 370 and/or a filter is provided to catch sediment waste 380). This allows for an automatic removal of floating waste 370 or sediment waste 380 within electrocoagulation system 310.

Electrocoagulation system 310 includes reaction chamber 320 and separator 330. However, reaction chamber 320 and separator 330 can be combined into a single batch chamber that conducts both an electrocoagulation reaction and a separation operation.

Reaction chamber 320 includes cathode 322 electrically coupled to anode 324. Reaction chamber 320 also includes free ions 326 (e.g., hydroxide ions and/or metal ions) provided from an external ion generator 340.

Ions produced by external ion generator 340 elevate the need for anode 324 to produce metal ions as a reaction proceeds. Because anode 324 is not producing ions and degrading a continuous reaction can take place without having to periodically replace a degraded anode 324. It may also reduce leaks forming about a dissolved anode.

External ion generator 340 separates metal ion generation from the electrochemistry at the anode-cathode assembly in reaction chamber 320. In traditional electrocoagulation systems, a given current is required to generate an adequate amount of metal ions for the electrocoagulation process, which often far exceeds a current necessary to generate adequate levels of hydrogen gas and hydroxide ions. The use of an external ion generator 340 reduces the amount of current that must be applied to reaction chamber 320 while still maintaining a relatively equal amount of metal ions and hydroxide ions. The reduced current saves energy while reducing anode degradation.

As shown, external ion generator 340 provides a source of free ions 326 directly to reaction chamber 320, as indicated by arrow 344. In another example, external ion generator 340 provides a source of free ions 326 to separator 330, as indicated by arrow 346. In another example, external ion generator 340 provides a source of free metal ions to a treatment stream 350, as indicated by arrow 342. In another example, a source of free metal ions is provided to a combination of treatment stream 350, reaction chamber 344, and/or separator 330. In another example, a source of free ions is indirectly provided to treatment stream 350, reaction chamber 344, and/or separator 330. In another example, one or more porous and/or perforated electrodes are used within reaction chamber 320, in order to encourage infusion of externally generated ions 326 through anode 324 and/or cathode 322. In some examples, the externally generated hydroxide ions and metal ions remain separate until the are provided to a point in electrocoagulation system 310.

The use of external ion generator 340 can allow for anode 324 to become a passive anode within reaction chamber 320. A passive anode is an anode that is not (or minimally) consumed chemically or electrochemically thus preventing it from needing to be replaced. External ion generator 304 provides metal ions to reaction chamber 320 while a reduced current is applied to anode 324 and cathode 322. The reduced current allows for a production of hydrogen gas and hydroxide ions, while allowing anode 324 to become a passive anode. Using a passive anode and extends an operational lifetime of anode 324. eliminates the need to periodically replace anode 324.

External ion generator 340 may include any one of a variety of metal ion generators. For example, external ion generator 340 may generate metal ions 326 from bulk or scrap metal sources. In one example, external ion generator 340 is an electrochemical reactor (e.g., common metal electrodes connected to a power supply). In another example, external ion generator 340 is a chemical reactor (i.e., acid baths, oxidizing agents, etc.). In another example, external ion generator 340 is an external tank with a dissolved salt solution (e.g., zinc chloride, copper sulfate, iron nitrate, aluminum nitrate, mercury chloride, nickel chloride, silver nitrate, platinum chloride, manganese sulfate, chromium chloride etc.). However, in other examples, external ion generator 340 may include any other source capable of providing or generating metal and/or hydroxide ions to a treatment stream 350, or electrocoagulation system 310.

One advantage of producing ions 326 in an external ion generator 340, for example, is that external ion generator 340 can use highly reactive metals, for example calcium, strontium, or lithium. Or the external ion generator 340 may use mechanically inferior metals, such as zinc, gallium, or mercury. Generating ions 326 externally, allows for the introduction of two or more coagulation chemistries, metal ion and/or another coagulation mechanism, simultaneously, sequentially, or both.

Cathode 322 and anode 324 include any appropriate anode/cathode combination, for example parallel plates, concentric non-parallel plates, concentric cones or pyramids, or other appropriate configurations.

FIG. 3B is a diagram showing the example reaction chamber 320. As shown, the hydroxide ions 326 and metal ions 326 are coagulating and capturing the waste within the water. In this example, free ions 326 are provided from external ion generator 340 rather than from an electrochemical reaction between anode 324 and cathode 322. As shown, this reduces the wear or degradation of anode 324, for illustration compare anode 324 of FIG. 3B with anode 120 of FIG. 1. In some examples, anode 324 does not degrade or wear. While anode 324 creates fewer ions compared to anode 120, anode 324 is still energized enough for electrons to flow from cathode 322 to anode 324. External ion generator 340 can create streams of ions into the reacton chamber 320 that are chemically balanced and neutralize each other in the treatment process producing a solid that is removed by a separator.

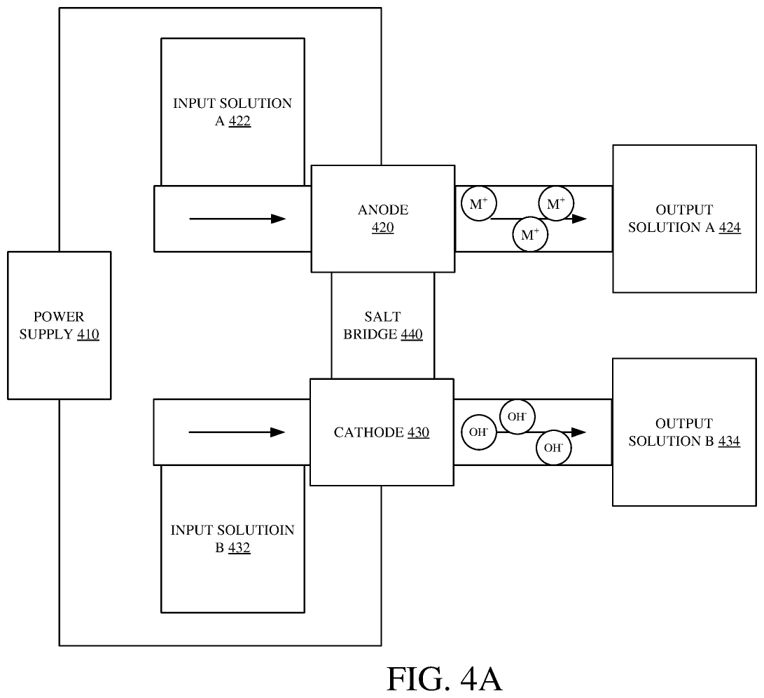

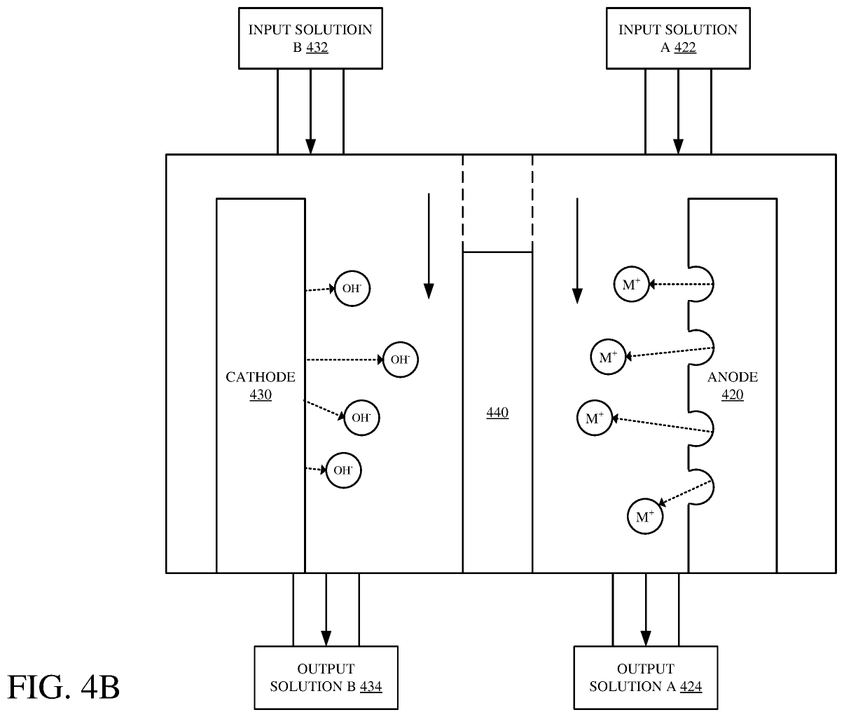

FIG. 4A is a diagram showing an example external ion generator. As shown, external ion generator 400 includes a power source 410 connected to a cathode 430 and anode 420. Whereby the cathode 430 is coupled to anode 420 by means of a salt bridge 440.

Sacrificial anode 420 may allow current passing through reaction chamber 320 to generate adequate levels of hydrogen gas and hydroxide ions, while providing a balance of free metal ions necessary for electrocoagulation. The use of a anode 420 greatly increases the lifetime of anode 324 in reaction chamber 320, as the anode erosion rate is directly related to the current passed through the anode-cathode assembly, and anode 324 in the anode-cathode pair, exposed to a lower amount of current, will have an operational life that is longer than conventional cathode-anode arrangements.

Anode 420 may include any common metal such as iron, aluminum, zinc, copper, titanium, magnesium, platinum, etc. Anode 420 may also include any metal that, when ionized, triggers an agglomeration of impurities within reaction chamber 320. Ionization is the process by which an atom or molecule acquires positive or negative charge by gaining or losing electrons to form ions. In some examples, anode 420 is located at an accessible location such that an operator can remove anode 420 after it has degraded.

Anode 420 including, for example, iron would lose electrons through oxidation to form a ferric ion. The oxidation of iron occurs as shown in the following formula (1) to produce ferric ions.

Fe(s)->Fe³⁺+3e⁻ Formula (1)

An input solution 422 can flow through anode 420 as a means of capturing the free metal ions produced to allow output solution 424 to become a source of free metal ions. The free metal ions can then be introduced into an electrocoagulation water treatment system, for example electrocoagulation system 310. Input solution 422 may include clean water or alternatively waste water. For example, input solution 422 can include waste water with unwanted contaminants such as hydrocarbons or suspended solid contamination. This allows external ion generator 400 to act as a pretreatment step because the metal ions generated in the anode may associate with the hydrocarbons and/or particulate contained in the waste water causing them to agglomerate. In the presence of hydrogen microbubbles, the agglomerates generated can float to the surface and be skimmed off the solution surface prior to treatment.

Cathode 430 may include any common metal such as iron, stainless steel, copper, aluminum, platinum, etc. Cathode 430 may also include any metal that allows for the electrolysis of water. Cathode 430 in external ion generator 400 remains passive, unlike sacrificial anode 420, and allows for water to be reduced thereby producing hydrogen gas as shown in formula (2).

2H₂O+2e⁻->H₂+2OH⁻ Formula (2)

An input solution 432 flows through cathode 430 as a means of capturing the hydroxide ions produced to allow output solution 434 to become a source of hydroxide ions. The hydroxide ions can then be introduced into electrocoagulation system 310. Adding additional hydroxide ions into electrocoagulation system 310, not only serves to increase the number of coagulating agents in electrocoagulation system 310 to help remove contaminants, but it also allows any excess metal ions to be removed from filtered water 360. Without an excess of hydroxide ions in electrocoagulation system 310, any metal ions that do not hydrolyze with hydroxide to bind to any contaminants will remain in filtered water 360. Input solution 432 may consist of clean water or alternatively waste water with unwanted contaminants (e.g., dissolved heavy metals). The hydroxide ions can bind to the dissolved heavy metals present in the waste water. This allows external ion generator 400 to act as a pretreatment step in the treatment process of the waste water.

Salt bridge 440 is used to connect cathode 430 and anode 420 to maintain the electrical neutrality within the circuit to prevent the reaction from reaching equilibrium too quickly. Salt bridge 440 allows conduction across it thereby completing the electric circuit while keeping input solutions 432 and 422 flowing through cathode 430 and sacrificial anode 420, respectively, separately to keep the hydroxide ions and metal ions produced separate until both are introduced into electrocoagulation system 310. The advantage to keeping the hydroxide ions and metal ions separate until introduced into electrocoagulation system 310 is to prevent the precipitation of hydroxide and metal ions prior to treatment which would render the metal ions inactive.

FIG. 4B is an illustrative diagram showing an example reaction in the example external ion generator of FIG. 4A. As shown, input solutions 422 and 432 are flowing into the external ion generator and being enriched with either hydroxide ions (input solution 432) or metal ions (input solution 422) and exiting the external ion generator as output solutions 424 which contains metal ions and output solution 434 which contains hydroxide ions. Divider 440 can be provided, in one example, to prevent the hydroxide ions from bonding with the metal ions before being supplied to a electrocoagulation water treatment system while still allowing for ion transfer between input solutions 422 and 432. In one example, divider 440 may comprise a cement board. In other examples, divider 440 may comprise a membrane.

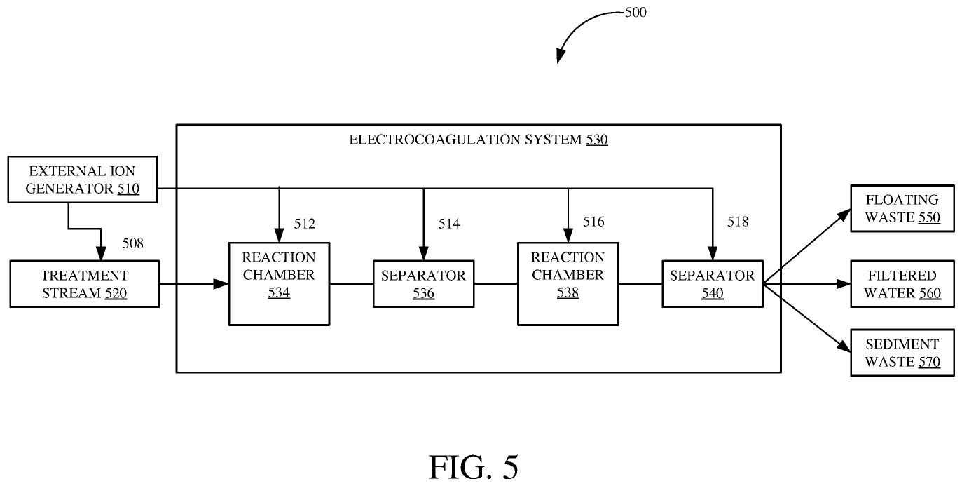

FIG. 5 is a diagram showing an example water treatment system with multiple chambers. As shown, water treatment system 500 includes an electrocoagulation system 530 with multiple, alternating reaction chambers and separators. However, it is to be understood that any number of reaction chambers and separators may be used, in a variety of available configurations.

Electrocoagulation system 530 includes multiple reaction chambers 534, 538 with multiple separators 536, 540. In another example, multiple reaction chambers 534, 538 are placed in series with one or more separators 536, 540. In another example, electrocoagulation system 530 is configured, as illustrated in FIG. 5, with reactors 534, 538 alternating between separators 536, 540. However, it is to be understood that any combination of reaction chambers and separators may be used.

Water treatment system 500 receives a treatment stream 520 of waste water with unwanted contaminants and produce filtered water 560. Based on the contaminants within treatment stream 520, floc may be produced after an electrocoagulation reaction is conducted within a reaction chamber of electrocoagulation system 530, e.g. reaction chambers 534 and/or 538. The floc may be ejected as either floating waste 550 or sediment waste 570, based on density of the floc, for example, from either/both of separators 536, 540.

Reaction chambers 534, 538 conduct an electrocoagulation reaction. Each of reaction chambers 534, 538 includes a cathode, an anode, and free ions. In another example, only one reaction chamber carries out an electrocoagulation reaction. This allows for a multiple reaction chamber system wherein other reactions are used in conjunction with an electrocoagulation reaction.

As shown, an external ion generator 510 provides a source of free ions to reaction chambers 534, 538. A source of free ions is provided to electrocoagulation system 530 at a variety of different points during the treatment process. As indicated by arrows 512-518, the free ions can be provided at a variety of different places in the treatment process. In some examples, a source of free metal ions is supplied (directly or indirectly) to any combination of reaction chambers and/or separators.

External ion generator 510 may include any one of a variety of free metal ion generators. In one example, external ion generator 510 is an electrochemical reactor such as he one shown in FIGS. 4A-4B. In another example, external ion generator 510 is a chemical reactor. For example, an acid bath, in one example, oxidizing agents or other suitable reactors configured to generate a source of free metal ions. In another example, external ion generator 510 is an external tank with a dissolved salt solution. However, in other examples, external ion generator 510 may include any other source capable of providing free ions.

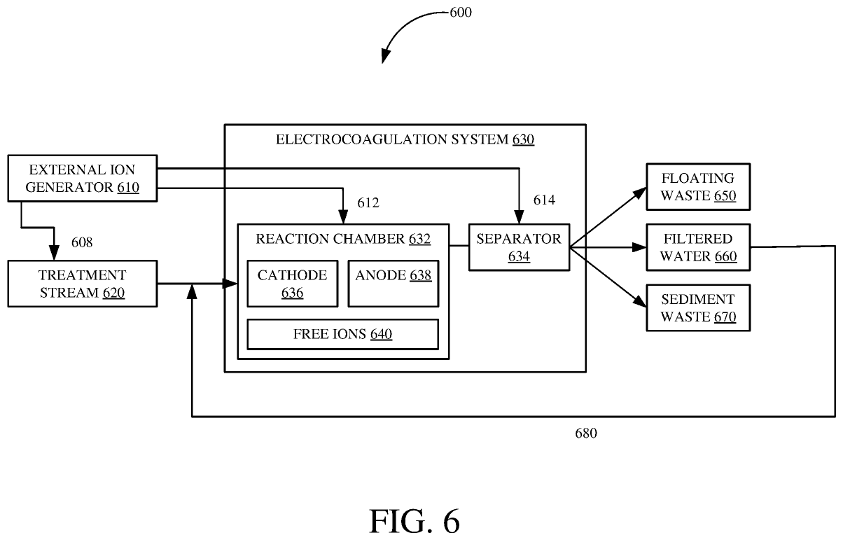

FIG. 6 is a diagram showing an example water treatment system with a recycle loop. A water treatment system 600 includes an electrocoagulation system 630 that is configured to receive a treatment stream 620 and produce filtered water 660. Treatment stream 620 includes waste water with a contaminant. Based on the contaminant within treatment stream 620, floc may be produced after an electrocoagulation reaction is conducted within a reaction chamber 632 of electrocoagulation system 630. The floc may be ejected as either floating waste 650 or sediment waste 670, based on density of the floc, for example.

As shown, at least a portion of filtered water 660 is cycled back into treatment stream 620 using a recycle loop 680. This allows for a multi-pass system that allows filtered water 660 to be recycled through electrocoagulation system 630 for a second pass.

Water treatment facility 600 includes electrocoagulation system 630, recycle loop 680, treatment stream 620, and an external ion generator 610. Recycle loop 680 includes a portion of filtered water 650 along with any remaining contaminates left over after a treatment process is completed. Recycle loop 680 is coupled to a treatment stream 620. However, in another example, recycle loop 680 is coupled to electrocoagulation system 630.

In one example, electrocoagulation system 630 includes reaction chamber 632 and a separator 634. In one example, reaction chamber 632 is configured to conduct an electrocoagulation reaction. In another example, separator 634 is configured to separate out any floating waste 640 and/or sediment waste 660 generated by reaction chamber 632. However, in one example, electrocoagulation system 630 only includes reaction chamber 632, such that any resulting waste from an electrocoagulation reaction is removed from reaction chamber 632. In one example, reaction chamber 632 includes any or all of a cathode, an anode, and free metal ions.

External ion generator 610 generates a source of free ions. As indicated by arrow 608, a source of free metal ions is provided to treatment stream 620. As indicated by arrow 612, a source of free metal ions is provided to reaction chamber 632. As indicated by arrow 614, a source of free metal ions is provided to separator 634. In some examples, source of free metal ions is provided (directly or indirectly) to any combination of treatment stream 620, reaction chamber 632, and/or separator 634.

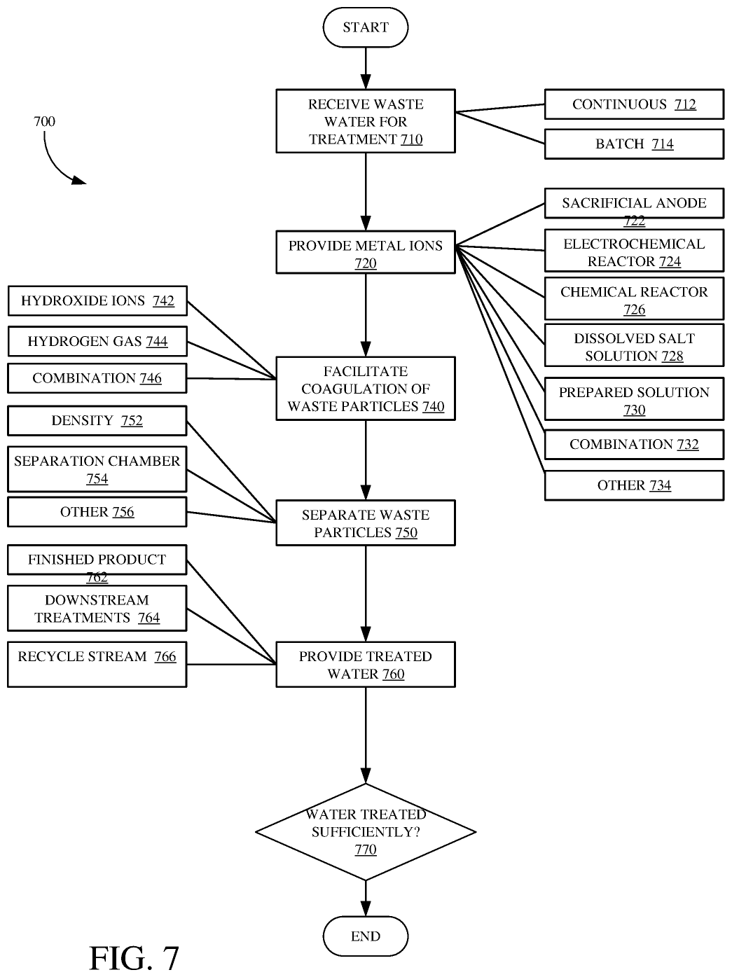

FIG. 7 is a flow diagram showing an example water treatment operation. Method 700 may be utilized for either a single or multi-pass waste water treatment system, for example, any of the systems described in FIGS. 2-3,5-6, or another suitable system.

At block 710, waste water is received. This may include a continuous waste stream flow through a waste water system, as indicated in block 712. In another example, a batch of waste water is received for treatment including a contaminant, as indicated in block 714.

At block 720, a source of free ions is generated and provided to a water treatment system. The source of free ions is provided to the water treatment system to carry out an electrocoagulation reaction. As indicated in block 722, the source of free ions is provided by a sacrificial anode. As indicated in block 724, the source of free ions is provided by an electrochemical reactor, such as the one shown in FIG. 4. As indicated in block 726, a chemical reactor provides the source of free ions. As indicated in block 728, a dissolved salt solution provides the source of free ions. As indicated in block 730, an already prepared solution, of the source of free ions, is provided. As indicated in block 732, a combination of different sources may be used to provide the source of free ions. However, as indicated in block 734, other mechanisms for providing a source of free ions may be used.

At block 740, a coagulation of waste particles is facilitated. In one example, the coagulation of waste particles is facilitated within a water treatment system after free metal ions and hydroxide ions are provided and are in solution with the waste water. The free metal ions and hydroxide ions come together to form polymeric ions that will coagulate and gather waste. As indicated in block 742, a coagulation of waste particles is facilitated by running a current across a cathode/anode assembly within the water treatment system, such that additional hydroxide ions are generated. As indicated in block 744, a coagulation of waste particles is facilitated by running a current across a cathode/anode assembly, such that hydrogen gas is generated. As indicated in block 746, a coagulation of waste particles is facilitated by running a current across a cathode/anode assembly, such that both hydroxide ions and hydrogen gas are generated. In another example, a current is run across a cathode/anode assembly such that few, or no free metal ions are generated at the cathode/anode assembly.

At block 750, produced waste particles are separated. The separation occurs naturally, such that less dense floc floats to the top of the reaction chamber and denser floc floats to the bottom of a reaction chamber, as indicated in block 752. This may allow for floc to be removed directly from a reaction chamber as sediment waste or floating waste. The separated waste is transferred out of an electrocoagulation system using a separation chamber, as indicated in block 754. This can involve running the waste water through multiple filters, such that floc is removed from the system. As indicated in block 756, another separation mechanism can be used.

At block 760, treated water is provided. As indicated in block 762, treated water is provided as a finished product. As indicated in block 764, treated water is provided for further downstream treatments. As indicated in block 766, treated water is recycled back through the system for at least a second pass. At block 770 it is determined if the water is sufficiently treated. If the water is sufficiently treated, the operation on the water ends. If the water is not sufficiently treated the water can be recycled back to block 710 where operation 700 repeats.

The descriptions of the various examples of the present disclosure have been presented for purposes of illustration but are not intended to be exhaustive or limited to the examples disclosed. Many modifications and variations will be apparent to those of ordinary skill in the art without departing from the scope and spirit of the described examples. The terminology used herein was chosen to explain the principles of the examples, the practical application or technical improvement over technologies found in the marketplace, or to enable others of ordinary skill in the art to understand the examples disclosed herein.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A water treatment system comprising:
a reaction chamber comprising an anode and a cathode, the reaction chamber being configured to conduct an electrocoagulation reaction using the anode and the cathode; and
an external ion generator, separate from the reaction chamber, configured to provide a source of free metal and hydroxide ions to the water treatment system.

2. The water treatment system of claim 1, wherein the source of free metal ions comprise zinc ions.

3. The water treatment system of claim 1, wherein the source of free metal ions is provided to the reaction chamber.

4. The water treatment system of claim 1, wherein the reaction chamber and the water treatment system also comprises a second reaction chamber in series with the reaction chamber.

5. The water treatment system of claim 1, further comprising a separator configured to separate waste generated by the electrocoagulation reaction, wherein the source of free metal ions are provided to the separator.

6. A water treatment system comprising:
an electrocoagulation system configured to receive a waste water stream, the electrocoagulation system further comprising:
a reaction chamber configured to carry out an electrocoagulation reaction using an anode and a cathode, wherein the electrocoagulation reaction is configured to produce a floc;
a separator configured to separate out the floc; and
an external ion generator, separate from the anode, configured to provide a source of metal ions and hydroxide ions to the electrocoagulation system; and
wherein the electrocoagulation system is configured to output a treated water stream.

7. The water treatment system of claim 6, wherein the source of free metal ions is provided to the waste water stream.

8. The water treatment system of claim 6, wherein the free metal ions and hydroxide ions are provided to the reaction chamber and the free metal ions and hydroxide ions remain separate until they are in the reaction chamber.

9. The water treatment system of claim 6, wherein the source of free metal ions is provided to the separator.

10. The water treatment system of claim 6, and further comprising a recycle stream configured to allow the treated water stream to pass through the separator at least twice.

11. The water treatment system of claim 6, wherein the source of free metal ions is configured to reduce an amount of current required to facilitate the electrocoagulation reaction.

12. The water treatment system of claim 6, wherein the reaction chamber is a first reaction chamber, and wherein the electrocoagulation system comprises a second reaction chamber coupled in series to the first reaction chamber.

13. The water treatment system of claim 12, wherein the separator is a first separator, and wherein the electrocoagulation system comprises a second separator coupled in series to the first separator.

14. A method for using an electrocoagulation reaction, comprising:
providing to a reaction chamber, a waste water source for treatment, wherein the reaction chamber comprises an anode and a cathode, and wherein the waste water source comprises a contaminant;
receiving a source of free metal ions, produced by a source other than the anode or the cathode;
running a current through the anode and the cathode, wherein the current is sufficient to trigger electrocoagulation of the contaminant into a floc; and
separating the floc from a treated fluid.

15. The method of claim 14, wherein the source of free metal ions is a sacrificial anode.

16. The method of claim 14, wherein the source of free metal ions is an electrochemical reactor.

17. The method of claim 14, wherein the source of free metal ions is a chemical reactor.

18. The method of claim 14, wherein the source of free metal ions is a dissolved salt solution.

19. The method of claim 14, wherein the waste water source is provided as a batch process.

20. The method of claim 14, and further comprising:
providing the treated fluid to the reaction chamber through a recycle loop;
running a second current through the anode and the cathode, wherein the second current is sufficient to trigger electrocoagulation of remaining contaminates in the treated fluid into a second floc; and
separating the second floc from the treated fluid.
